(19) United States
(12) Patent Application Publication
(10) Pub. No.: US 2024/0240335 A1
(43) Pub. Date: Jul. 18, 2024

(54) NOx ACTIVATION TO AMMONIA

(71) Applicant: NewSouth Innovations Pty Limited, Sydney, New South Wales (AU)

(72) Inventors: Rahman Daiyan, Sydney (AU); Rose Amal, Sydney (AU); Emma Lovell, Sydney (AU); Ali (Rouhollah) Jalili, Sydney (AU)

(21) Appl. No.: 18/554,292

(22) PCT Filed: Apr. 7, 2022
(86) PCT No.: PCT/AU2022/050309

§ 371 Date: Oct. 6, 2023

(30) Foreign Application Priority Data
Apr. 7, 2021 (AU) 2021901015

(51) Int. Cl. C25B 11/077; B01D 53/32; B01D 53/86; C01C 1/02; C25B 1/27; C25B 11/052; C25B 11/065

(52) U.S. Cl. CPC C25B 11/077; B01D 53/326; B01D 53/8628; C01C 1/026; C25B 1/27; C25B 11/052; C25B 11/065; B01D 2255/20761; B01D 2255/806; B01D 2257/404

(57) ABSTRACT

Metal oxide catalyst, preferably in a high surface area form, comprising a metal oxide (e.g. copper, cerium, tin or bismuth) having engineered surface defects in the form of oxygen vacancy defects. The engineered surface defects may be created by plasma treatment for a time sufficient to create oxygen vacancy defects while maintaining morphology and crystallinity of the metal oxide surface. Also a method of producing a metal oxide catalyst for NOx reduction by preparing a high surface metal oxide catalyst and plasma treating the metal oxide particle to induce a controlled level of defects. Also, a method of producing NH₄₊ from NOx comprising depositing the metal oxide catalyst onto a substrate to provide an electrode, or a metal coordinated with nitrogen doped carbon, contacting the electrode with an aqueous solution containing NOx species and applying a current to the electrode to reduce NOx species to NH₄₊/NH₃.

### FIELD OF THE INVENTION

The invention relates to processes and catalysts for the conversion of nitrogen oxide species (NOx) into ammonia.

### BACKGROUND

Nitrogen oxides (NOx) are chronic industrial pollutants, produced from the near unavoidable oxidation of nitrogen during fuel combustion in air. Not only are NOx compounds toxic, but they also contribute to the production of acid rain which can lead to direct environmental damage.

Thus, it is highly desirable from an industrial and environmental point of view to have a process which can capture and convert NOx species to inert, or ideally useful, species.

Selective Catalytic Reduction (SCR), using a catalyst to drive a reaction of NOx species with ammonia or urea is a common process used for reducing NOx emissions to nitrogen gas in use at power stations, industrial manufacturing processes and on heavy vehicle emitters. SCR is capital intensive and consumes valuable commodity chemicals. In addition, the use of urea results in CO₂ emissions, meaning that the process still has a negative environmental impact.

Ammonia (NH₃) is emerging as a critical vector in various renewable Power-to-X (P2X) pathways to transform and decarbonize the global energy and chemical industry. In addition to its primary use as a fertilizer, ammonia is advocated as an energy carrier for the evolving global hydrogen economy as it is stable and can be transported over large geographical distances using current logistical infrastructure. For end use, the chemical can be split to separate hydrogen, directly combusted to generate electricity or used as feedstock in manufacturing. Given that the majority of global NH₃ market (primarily for fertilizer) is supplied using capital and energy-intensive Haber-Bosch (HB) process that requires high pressure, temperature and high purity H₂ (produced using steam methane reforming) and N₂ (from air liquefaction), there is a strong incentive to develop and deploy alternative renewable powered P2X technologies that can generate NH₃ at different scale.

A number of direct renewable power-to-ammonia routes are being actively explored to decarbonize NH₃ market including: (i) electrochemical N₂ reduction to NH₃ (eNRR), (ii) plasma-driven conversion of air into NH₃, and (iii) electrocatalytic reduction of NOx (i.e. NO₃_{^{−}} and NO₂_{^{−}}) to NH₃ (NOₓRR). Of these routes, NOₓRR is emerging as a viable contender owing to the large attainable yields as the solubility of NO₃_{^{−}} and NO₂_{^{−}} in aqueous solution is high (compared to N₂), enabling it to be reduced to NH₃ easily (compared to eNRR) and the products can be directly attributed to come from NOₓ reduction than from impurities. Further, the widespread availability of NOₓ from large-emitting sources (such as powerplants and industry) and from wastewater alongside matured capture technologies provide significant opportunity to convert these waste emissions, allowing the closing of the NOₓ loop (FIG. 1a). This prospect of NOₓRR will become increasingly important and more adoption of NH₃ within the energy mix will inevitably lead to more production of NOₓ (specifically through combustion).

A range of materials and strategies have been employed to deliver high yields during NOₓRR. For instance, pristine Cu foam was reported generate NH₃ with a large yield of 517 μmolcm⁻²h⁻¹, albeit at a very high operating potential of −0.9 V vs reversible hydrogen electrode (RHE) in NO saturated 0.25M Li₂SO₄. Similarly, Cu centres within organic molecular complex exhibits an NH₃ production rate of 436±85 μgh⁻¹ cm⁻² at a low potential of −0.4 V vs RHE. Very recently, defects such as oxygen vacancies are being reported to be beneficial for NOₓRR, owing to the improved binding of NO⁻ ions within the vacancies and as a result, defective TiO₂ catalyst, can generate ammonia with a yield of 0.05 mmolh⁻¹ mg⁻¹. Despite this progress, there remains gaps in our understanding of the active sites that are responsible for nitrate reduction to ammonia, in place of the competing hydrogen evolution reaction (HER), that can also take place in the same reaction environment. Specifically, to the best of our knowledge, there remains no systematic investigation into the tuning of defects and coordination and correlating their performance for NOₓRR.

### SUMMARY

According to a first aspect the invention provides a metal oxide catalyst in the form of nanoparticles, said metal oxide catalyst having engineered surface defects in the form of oxygen vacancy defects.

The metal may be any suitable metal, such as for example, a transition metal, a lanthanide metal or a post-transition metal. For preference, the metal is a transition metal such copper, or a lanthanide metal such as cerium, or a post-transition metal such as tin and bismuth. The invention will be disclosed and discussed herein with respect to copper as the metal, but it will be appreciated that it is equally applicable to other metals.

In some embodiments, the metal may be selected from copper, cerium, tin or bismuth. Alternatively, the metal may be selected from copper, cerium, or bismuth; or the metal may be selected from copper, cerium, or tin; or the metal may be selected from copper, tin or bismuth; or the metal may be selected from cerium, tin or bismuth. Alternatively, the metal may be selected from copper or cerium, or the metal may be selected from copper or tin; or the metal may be selected from copper, or bismuth; or the metal may be selected from cerium, or tin; or the metal may be selected from cerium or bismuth; or the metal may be selected from tin or bismuth.

When the metal is copper, the catalyst is CuO with oxygen vacancy defects. When the metal is cerium, the catalyst is CeO₂ with oxygen vacancy defects and when the metal is bismuth, the catalyst is Bi₂O₃ with oxygen vacancy defects.

If desired the metal oxide catalyst may be supported on a substrate, for example a carbon substrate, such as a carbon fibre paper substrate and carbon cloth.

The metal oxide catalyst of the present invention is broadly prepared by a two stage process, firstly, preparation of a high surface area metal oxide in the metal's native oxidation state, and secondly plasma surface modification of the high surface area metal oxide to produce regions of oxygen deficiency (oxygen vacancy defects) at the metal oxide catalyst surface.

The metal oxide may be prepared by any conventional process for forming high surface area metal oxides. Examples include flame spray pyrolysis, electrodeposition, hydrothermal synthesis, precipitation etc. The invention will be disclosed herein with reference to flame spray pyrolysis, but it will be appreciated that any technique can be utilised to produce a high surface area catalyst.

The plasma surface modification can be conducted by any suitable plasma that can remove surface oxygen from the metal surface. For instance, the plasma may be a helium plasma, an argon plasma, a hydrogen plasma, a nitrogen plasma, an air plasma or mixtures thereof. For preference, the plasma is a helium plasma, argon plasma or a mixed plasma.

A high surface area refers to a catalyst having a high electrochemical surface area (ECSA). Those skilled in the art will be aware that the higher the ECSA the better. A high surface area catalyst would for instance have an ECSA greater than 10 m²/g, preferably greater than 50 m²/g and more preferably greater than 100 m²/g

Any suitable level of surface oxygen defect will catalyse the conversion of NOₓ to Ammonium.

The plasma treatment is applied for a time sufficient to create defects while maintaining morphology and crystallinity without inducing surface amorphization. Those skilled in the art will appreciate that a variety of experimental parameters, including the initial morphology of the metal oxide, will affect the exact etching time required to achieve and an optimal combination of oxygen defective sites without leading to surface amorphization or decreasing crystallinity or gelling, which removes accessible reduction sites on the catalyst surface. For a given metal oxide and prepared and etched under the same experimental regime, controlled variation of the etching time will enable the optimal surface vacancy to be determined.

For example, in the case of a CuO catalyst prepared by flame spray pyrolysis, the plasma treatment is optimally applied for 3-7 minutes, and more preferably, the plasma treatment is applied for 5 minutes.

According to a second aspect the invention provides a method of producing a metal oxide catalyst for NOₓ reduction, the method comprising:
preparing a high surface metal oxide catalyst; and
plasma treating the metal oxide particle to induce a controlled level of defects.

For instance, the invention provides a method of producing a CuO catalyst for NOₓ reduction, the method comprising:
preparing CuO nanoparticles by flame-spray pyrolysis; and
plasma treating the CuO nanoparticles to induce a controlled level of defects.

Preferably the flame spray pyrolysis for preparing CuO catalysts utilises an organochelated copper compound in a combustible solvent, for example, the organochelated copper compound is copper 2-ethylhexonate. The combustible solvent may be an aromatic hydrocarbon, such as xylene. Preferably, the organochelated copper compound has a concentration in the range of 0.1-1.01M, for example, the organochelated copper compound has a concentration in the range of 0.5M.

In one embodiment, the flame spray pyrolysis deposits the CuO nanomaterial on a glass fibre filter.

According to a third aspect the invention provides a method of producing NH₄_{⁺} from NOₓ comprising depositing a metal oxide catalyst of the first aspect, or a metal oxide catalyst prepared according to the second aspect onto a substrate to provide an electrode, or a metal coordinated with nitrogen doped carbon, contacting the electrode with an aqueous solution containing NOₓ species and applying₄ a current to the electrode to reduce NOx species to NH₄_{⁺}.

The nitrogen doped carbon may have any coordination structure, including but not limited to Cu—N4, Cu—N3-C1, Cu—N2-C2, Cu—N3-V1, Cu—N2-V2.

The method may further comprise the step of monitoring NOX reduction by analysis of NH₄₊ production in the aqueous solution.

According to a fourth aspect the invention provides a method of producing NH₃ from NOₓ comprising depositing a metal oxide catalyst of the first aspect, or a metal oxide catalyst prepared according to the second aspect onto a substrate to provide an electrode, contacting the electrode with an aqueous basic solution containing NOₓ species and applying a current to the electrode to reduce NOₓ species to NH₃.

The method may further comprise the step of monitoring NOₓ reduction by analysis of NH₃ production in the aqueous basic solution.

The process may also be carried out in the gas phase, where NOₓ species and a hydrogen donor in gas form are passed over the catalyst of the present invention.

The NOₓ may be part of a waste stream.

### DESCRIPTION OF THE DRAWINGS

FIG. 1. (a) Schematic displaying the closed loop nitrate reduction reaction pathway that can be used to convert waste NOₓ (from powerplant, industry and wastewater) to NH₄_{⁺} (which can be used as fertilizer or converted to NH₃ for use as feedstock). (b) Benchmarking ammonia production yield with our defective CuO with Li intermediary, eNRR systems and NOₓRR catalysts. (c) Economic modelling showing the importance of reducing cell voltage and increasing current density to lower the levelized cost of ammonia generation. (d-f) Theoretical results assessing the role of defects in catalyzing nitrate to ammonia and HER. (d) The pristine CuO (111) slab model used in DFT calculations and top view of the relaxed structures of CuO (111) surface with 1, 2 and 3 OVs, with the circles highlighting the missing oxygen atoms. (e) Calculated adsorption energies of the NO⁻ ion on the CuO (111) surface with no, 1, 2 and 3 OVs. (f) The corresponding HER free energy diagram.

FIG. 2. Defect Engineering in CuO for NOₓRR. (a) Linear sweep voltammetry (scan rate 5 mV s⁻¹) and (b) dependence of NH₄_{⁺} yield on applied potential for CuO, pCuO-5 and pCuO-10 in H-cell containing 0.05M KNO₃ and 0.05M H₂SO₄. (c) Linear sweep voltammetry (scan rate 5 mV s⁻¹) and (d) dependence of NH₄_{⁺} yield on cell voltage with pCuO-5 in custom designed flow electrolyzer. (e) Chronoamperometric i-t curve for pCuO in flow electrolyzer at 2.2 V for duration of 10 hours. (f) Economic modelling of NOₓ capture and conversion to NH₄_{⁺} using pCuO-5 in a 10 MW electrolyzer system.

FIG. 3. Morphology and surface characterizations for defective CuO. TEM and HAADF imaging showing lattice fringes for (a,b) FSP CuO, (c-d) pCuO-5 and (e-f) pCuO-10. (g) High-resolution Cu 2p XPS spectra for FSP CuO, pCuO-5 and pCuO-10. X-ray absorption profiles of CuO and plasma-treated CuO. (h) Experimental XANES spectra at Cu K-edge and the magnified curves (insets) of FSP CuO and pCuO-5. (i) Fourier transformed (FT) magnitudes of best fit of FSP CuO and pCuO-5.

FIG. 4. (a) EPR spectra of FSP CuO, pCuO-5 and pCuO-10. (b) Operando Raman spectra of pCuO-5 drop-casted on screen-printed microelectrode (SPE) at different conditions and potentials. From the bottom to the top: Raman measurements at open circuit potential (OCP) without electrolyte, OCP with 0.05 M KNO₃+0.05 M H₂SO₄ (electrolyte), different potential in electrolyte and post-reaction OCP without electrolyte. (c) DFT-based free energy diagram detailing the mechanism of NOₓRR on the CuO (111) surface with 2 OVs.

### DESCRIPTION

The catalyst has been engineered by plasma treatment to produce specific surface oxygen defects. This result dramatically increases the rate of reaction allowing high NOx conversion rates, and a potentially green, scaleable approach to NOx reduction.

The present inventors have discovered that defective metal oxide nanomaterials are capable of generating high NH₄_{⁺} yields during NOₓRR. Defective metal nanoparticles can be prepared via a variety of processes, for example commercial flame-spray pyrolysis (FSP), electrodeposition, hydrothermal synthesis, precipitation etc. the product of which was then subject to a further mild plasma treatment to induce surface defects in the form of oxygen vacancy defects.

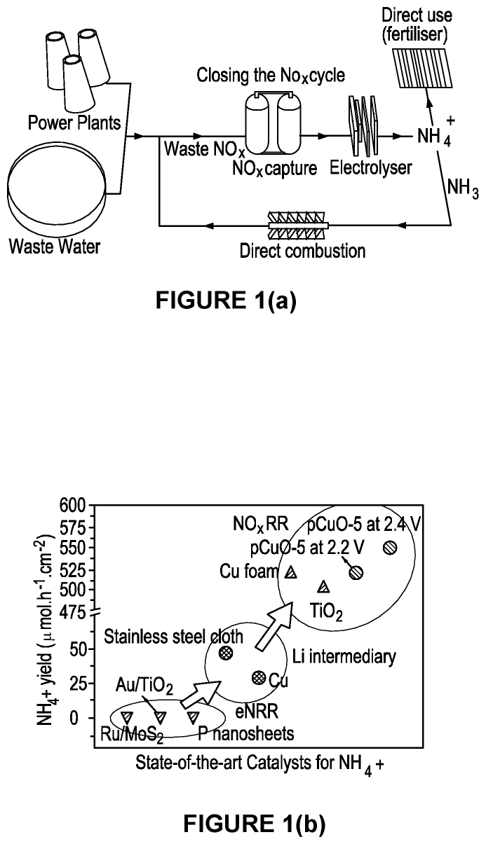

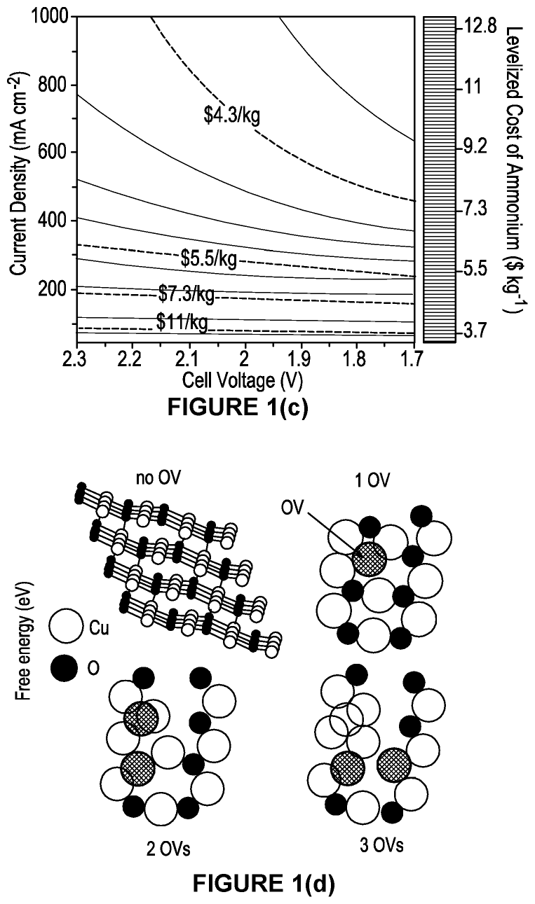

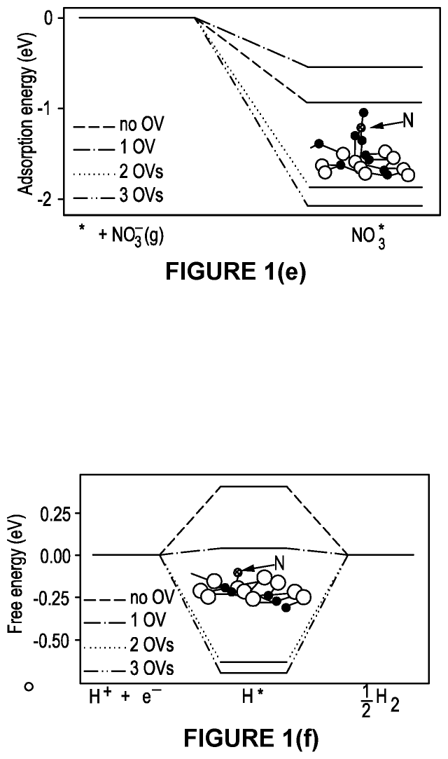

The ability of those defective metal oxide nanomaterials to carry out NOₓRR showed a direct dependence of defect density with the NH₄_{⁺} yield. In certain embodiments, the plasma-treated metal oxide of the present invention, in particular CuO that has been subjected to 5 minutes of plasma treatment, (pCuO-5) can attain a NH₄_{⁺} yield of 292 μmolcm⁻²h⁻¹ at −0.6 V vs RHE. This activity can be further boosted up to 520 μmolcm⁻²h⁻¹ at a cell voltage of 2.2 V within a flow electrolyzer with good stability over 10 hours of operation, demonstrating the scalability of the catalysts of the present invention for large-scale applications (FIG. 1b).

Critical to the feasibility of electrochemical reduction of NOx to NH₄_{⁺} (NORR), as a pathway for renewable Power-to-X (P2X) and to close the NOx cycle for emerging NH₃ economy, is the requirement of inexpensive, scalable and selective catalysts that can generate NH₄_{⁺} with high yield (FIG. 1c). In particular embodiments, the present invention provides an electrolyzer system that can convert dissolved NOx in the form of nitrates and nitrites to ammonia with a record yield of 82 g of ammonia per m² of electrode per hour.

In order to demonstrate the commercial feasibility of the present conversion catalyst and system, comprehensive technoeconomic modelling was carried out which revealed a NH₄_{⁺} levelized cost of $7.93/kg, inclusive of capture costs. The present invention thus provides an excellent trade-off between catalyst activity and selectivity for NOₓRR through simple defect engineering, indicating its suitability as a renewable Power-to-X pathway and to close the NOₓ cycle.

In order to gain insights into the role of oxygen vacancy defects within metal oxide catalysts for NOₓRR and also the competing hydrogen evolution reaction (HER) reaction, the present inventors first carried out density functional theory (DFT) calculations, using CuO as an example.

A CuO (111) surface without oxygen vacancies (OVs), and with one, two and three OVs as structural models (FIG. 1d) were chosen as structural models. It is generally accepted that a catalyst which combines favourable NO₃_{^{−}} adsorption with poor H⁺ to H₂ conversion leads to enhanced NOₓRR.

Thus, the present inventors first carried out NO₃_{^{−}} adsorption (FIG. 1e) and HER (FIG. 1f) free energy calculations on the potential structures. Generally, it was observed that the adsorption energy of NO₃_{^{−}} increases with increasing OV concentration on the surface of CuO (111)—with adsorption energy values of −0.93 eV and −2.08 eV on CuO (111) with no OV and 3 OVs, respectively (FIG. 1e). The negative adsorption energy values indicate that NO₃_{^{−}} adsorption is indeed energetically favourable on these surfaces. The result also points to the fact that NO₃_{^{−}} adsorption becomes increasingly favourable inhibiting competitive adsorption of other anions onto the CuO surfaces. The HER free energy calculations (FIG. 1f) revealed that the H⁺ binding energy also increases with increasing number of OVs. It was noted that, with increasing OV, the free energy of H⁺ goes from +0.41 eV (no OV) to +0.04 eV (1 OV) to −0.68 eV (3 OVs). This shows that although at low OV concentrations, the HER can be pronounced; it becomes increasingly difficult (as free energy drifts far away from 0 eV) at higher OV concentrations. Taken together, these theoretical predictions suggested that defective CuO nanomaterials have the potential to function effectively as high-yield and selective NOₓRR catalysts.

Proceeding from these calculation, defective CuO nanomaterials of the present invention were prepared using a scalable flame-spray pyrolysis synthesis strategy.

Flame spray pyrolysis is a known process in which a an organometallic precursor solution is aerosolised and an injected into a flame. The metal oxidises and the resultant fine powder of the metal oxide is collected. In the present invention, a precursor solution consisting of copper 2-ethylhexonate dissolved in 2-ethylhexanoic acid and xylenes was fed to the FSP nozzle with a flow-rate of 5 mL min⁻¹. Any suitable source of organo-chelated copper could be used, provided the ligand is sufficiently volatile and readily dissociates from the Cu under combustion conditions. The high-temperatures enabled by this process allow the formation of defective metal oxides that were previously demonstrated to be beneficial for electrocatalytic reduction reactions as it allows improved binding of the reactants on the vacancy sites.

As mentioned above, any known technique can be used to prepare the metal oxide, such as electrodeposition, hydrothermal synthesis, precipitation etc.

In the invention as exemplified, the FSP CuO thus prepared was then drop-cast on carbon fiber paper (CFP) to prepare an electrode which was subsequently tested for NOₓRR using an electrolyte that consists of 0.05 M KNO₃ and 0.05 M H₂SO₄.

The NOₓRR polarization curves were established for a number of electrolytes and overall demonstrated a much-enhanced j with FSP CuO, attaining −48 mA cm⁻² at −1 V compared to the reference Cu foam which can attain −24 mA cm⁻². Bulk electrolysis at fixed potential was then carried out with FSP CuO and a maximum yield of 162 μmolcm⁻²h⁻¹ can be observed at −0.5 V. In comparison, the reference Cu foam presented a much lower NH₄_{⁺} yield, with a maximum yield of 35 μmolcm⁻²h⁻¹ at −0.8 V.

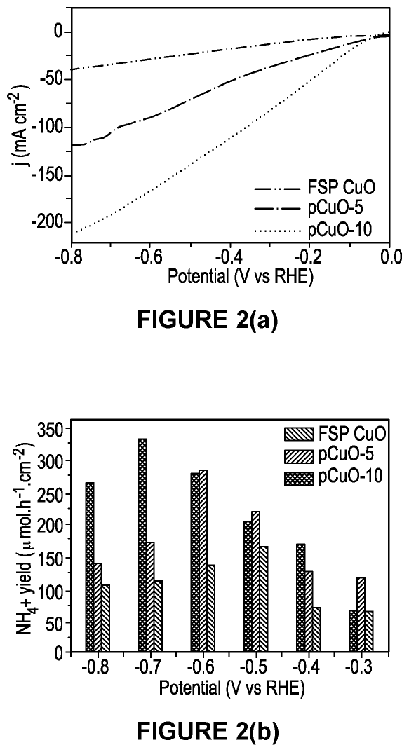

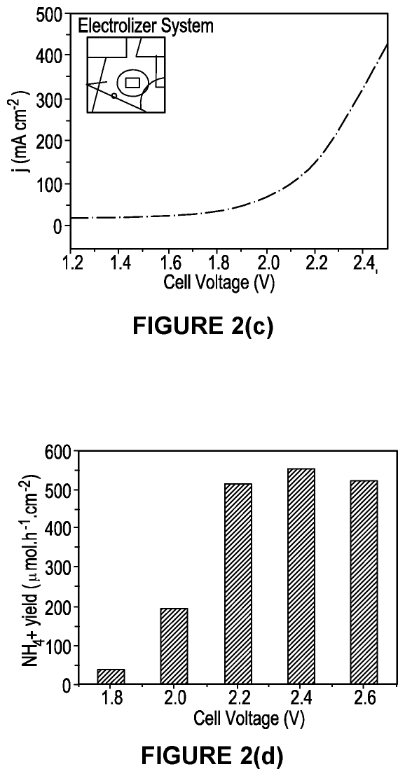

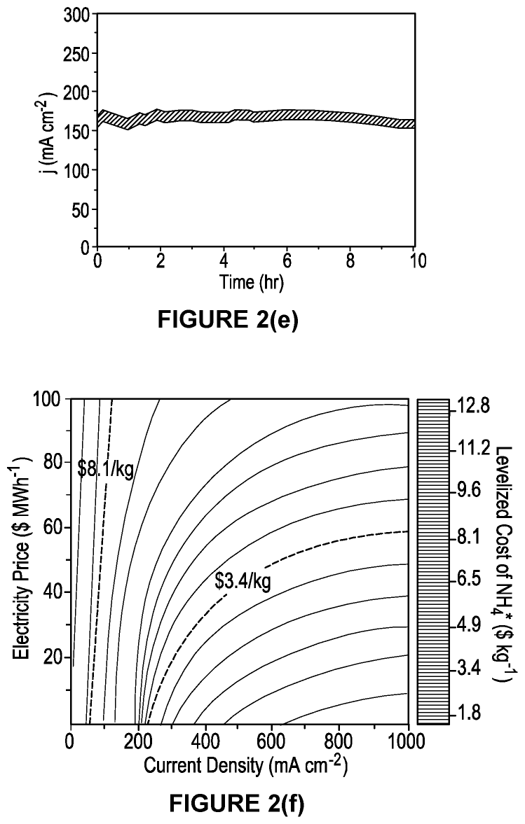

With these activities established, the FSP CuO of the present invention was used as the starting material for further modification. He plasma treatment for 5 (pCuO-5) and 10 (pCuO-10) minutes were applied to vary defect density and modify morphology to further improve NOₓRR yield and selectivity. These catalysts were tested for NOₓRR and revealed a drastic increase in j with increasing plasma treatment time (FIG. 2a), with j increasing from −46 mA cm⁻² (FSP CuO) to −120 mA cm⁻² (pCuO-5) to −210 mA cm⁻² (pCuO-10) at −0.8 V, respectively.

Bulk electrolysis was then carried out at different fixed potentials to investigate the yield and selectivity during NOₓRR. As revealed in FIG. 2b, increase in plasma treatment duration leads to an increase in NH₄_{⁺} yield, with the maximum yield attained with FSP CuO, pCuO-5 and pCuO-10 being 162 μmolcm⁻²h⁻¹, 290 μmolcm⁻²h⁻¹ and 334 μmolcm⁻²h⁻¹ at −0.5V, −0.6 V and −0.7 V, respectively. A 5-minute plasma treatment improves the selectivity of NH₄_{⁺} generation (when compared to FSP CuO) but subsequent treatment time leads to poorer FE_{NH4}_{⁺}. The maximal FE_{NH4}_{⁺} attained with FSP CuO, pCuO-5 and pCuO-10 are 72%, 89% and 69% at −0.5 V, respectively. This trade-off between activity and selectivity for NOₓRR is akin to other energy conversion reactions and may arise due to the changing defect density and possible surface chemical modification between the catalysts, as discussed below.

The etching process removes oxygen from the metal oxide to create surface defects, but also concomitantly decreases the crystallinity of the surface and potentially the total number of active surface sites.

This etching process, in the case of copper, lead to unmodified regions of Cu(II) and removes oxygen to create modified regions of Cu(I). The bulk oxidation state of the surface is this somewhere between +2 and +1, and advantageously about 1.5.

Continued etching produces more vacancies, moves the bulk oxidation state of the surface towards Cu(I) and reduces surface crystallinity.

Additionally, the catalytic performance can be diminished by over etching. The creation of vacancies results in the surface region being less conductive, thus, the extent of etching also impacts the catalyst performance in this way.

In order to translate this activity for large scale applications, the selective pCuO-5 was evaluated within a high-throughput flow electrolyzer. A membrane electrode assembly (MEA) was prepared that comprises pCuO-5 spray coated on CFP, Nafion membrane and a commercial RuO₂/Ti anode sandwiched together. The MEA was placed within a cell and 0.05M KNO₃ and 0.05M H₂SO₄ were used as the catholyte and 0.1 M H₂SO₄ as the anolyte. The results of potentiostatic experiments were then determined. The polarization curve (FIG. 2c) reveal a high j with the electrode, attaining 410 mA cm⁻² at 2.5 V. Fixed potential electrolysis revealed an enhanced NH₄_{⁺} yield (compared to H-cell measurements) and the pCuO-5 electrode is capable of displaying a high yield of 554 μmolcm⁻²h⁻¹ at a cell voltage of 2.4 V (FIG. 2d). It was seen that the pCuO-5 electrode can maintain this high activity over long duration, as evident by the steady i-t profile and stable NH₄_{⁺} yield of ˜520 μmolcm⁻²h⁻¹, highlighting the practicality of these electrodes for commercial applications (FIG. 2e).

Benchmarking this activity with state-of-the-art NOₓRR results (FIG. 1b), it can be seen that the catalyst and system of the present invention is amongst the highest for NH₄_{⁺} yield and is at least a magnitude higher compared to alternate power-to-NH₃ pathways such as eNRR and Li-mediated NRR. Notably, the pCuO-5 attains a stable NH₄_{⁺} rate of 86 g·m⁻²h⁻¹, which surpasses the CSIRO target (60 g·m⁻²h⁻¹)

A comprehensive economic analysis was then carried out to determine the feasibility of this Power-to-X pathway. As expected, there is a trade-off between electricity pricing and electrolyzer capacity factor (which are dependent on source of electricity) and ultimately the present invention is able to generate NH₄_{⁺} at a cost of $7.93 kg⁻¹ (using grid electricity configuration). Increasing the j for pCuO-5 from 150 mA cm⁻² to 800 mA cm⁻² enables the DoE target to be met and the LC_{NH4}_{⁺} to $3.95 kg⁻¹.

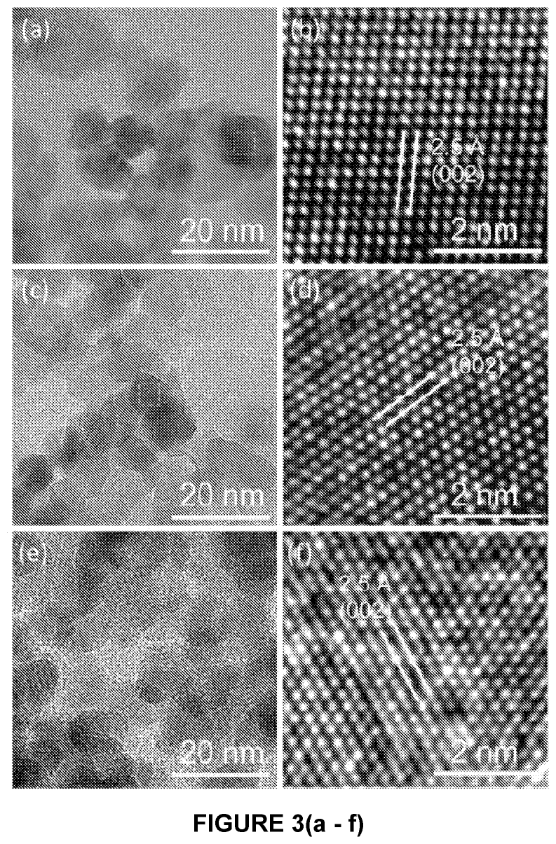

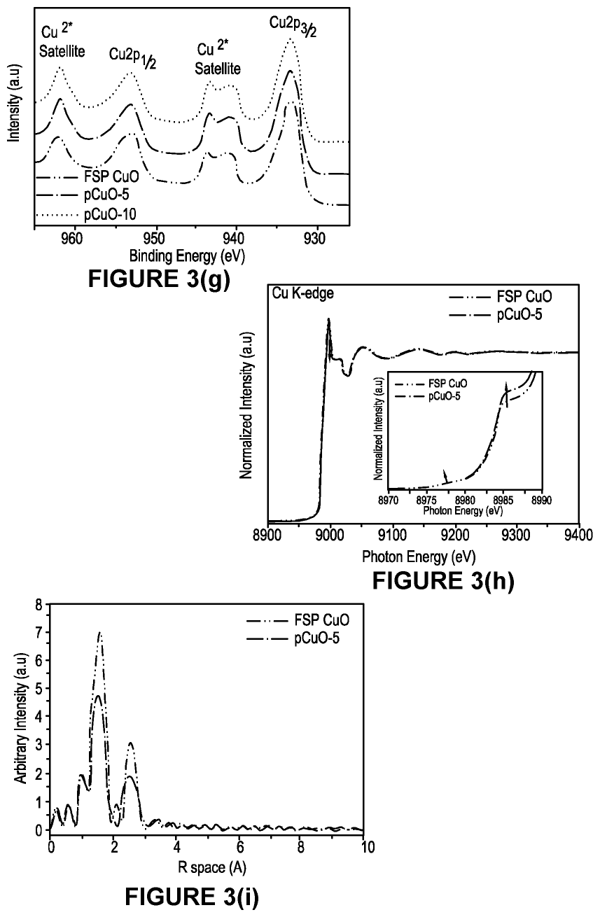

To experimentally establish the defect-activity relationship within the catalysts (as proposed by theoretical calculations in FIG. 1e-f), a series of physiochemical and electrochemical characterizations were carried out. The transmission electron microscopy (TEM) image of FSP CuO reveals the formation of crystalline anisotropic particles (FIG. 3a), which are characteristic of FSP fabrication synthesis. The high-angle annular dark field (HAADF) imaging of FSP CuO (FIG. 3b) nanomaterials reveal a crystalline ordered structure as evident from the aligned bright dots (Cu atoms) and lattice fringes with a spacing of ˜2.3 Δ, which correspond to CuO {002} facets. Upon mid-plasma treatment (5 min), the surface morphology remains similar with negligible variation in particle size (FIG. 3c), albeit the corresponding HAADF image (FIG. 3d) reveal a visible disorder and distortion. When CuO was exposed to longer plasma-treatment (10 min), a visible decline in crystallinity of the particles in the HR-TEM images (FIG. 3e) was noted that arises from excessive defect formation (FIG. 3f). Notably, the X-ray diffraction (XRD) patterns with the catalysts reveal no obvious change in bulk crystallinity between the samples, indicating that the changes arising from plasma-treatment are confined to the surface of the catalysts only. Note that the plasma-treatment duration did not lead to significant increase in electrochemical surface area (ECSA) for the catalysts, ruling out the effect of electrochemical surface area enhancement from plasma treatment as the major source for improved NOₓRR activity.

To investigate the surface chemistry of the catalysts, X-ray photoelectron spectroscopy (XPS) measurements were performed. The survey spectra of the catalysts reveal presence of Cu, O and background C. FIG. 3g displays the high-resolution deconvoluted Cu 2p XPS spectra for the catalysts, which reveal a peak at binding energy ˜933.5 eV that corresponds to the formation of Cu²⁺, within our catalysts and no presence of metallic Cu or Cu⁺ can be detected. Additionally, to further confirm the formation of Cu²⁺ on the surface of the catalysts, Auger Electron Spectroscopy (AES) was performed. It can be observed from AES spectra that the Auger parameter (i.e. the summation of binding energy for Cu²⁺ and kinetic energy from AES) for all the catalysts are >1850 eV, suggesting that the predominant oxidation state on the surface of all the as-synthesized catalyst is Cu²⁺. Note that there is a slight peak shift to higher binding energy for pCuO-10 electrode, indicating a lower electron density of the catalyst when compared to FSP CuO and pCuO-5, further confirming a slight decline in crystallinity of the catalyst surface (as revealed above using HR-TEM imaging). The high-resolution O1s spectra also corroborates the formation of Cu²⁺ in all the catalysts, as evident by the sharp peak at binding energy 529.5 eV. The FSP CuO shows a peak at binding energy 531.5 eV, that corresponds to the presence of oxygen vacancy defects within CuO and this peak intensity increases with increased plasma-treatment duration, highlighting a greater formation of oxygen vacancy defects arising from plasma-treatment.

Raman spectroscopy measurements with all three catalysts reveal strong signals at wavenumber 290 cm⁻¹ which correspond to A_{g} and peaks at 328 cm⁻¹ and 608 cm⁻¹ that correspond to B_{g} vibration modes of CuO. Note that the formation of other minor peaks in the Raman spectra may arise from formation of Cu₂O and surface defects which can break the translational symmetry of the lattice which leads to appearance or disappearance of Raman peaks compared to perfect crystals. Among these minor peaks, the peaks at 451, 550 and 640 cm⁻¹ are related to the minor presence of Cu₂O within the catalysts. The plasma-treatment with FSP CuO leads to a declining intensity for the Raman peaks that can be related to either decrease in surface crystallinity and/or increased formation of defects (as XRD patterns and TEM imaging reveal no obvious change in crystal size for CuO owing to plasma-treatment).

X-ray absorption spectroscopy (XAS) measurements with the catalysts were conducted to determine change in oxidation state and electronic structure of the CuO nanomaterials arising from plasma-treatment. The X-ray absorption near-edge fine structure (XANES) of Cu K-edge (FIG. 3h) indicate that the pCuO-5 shift towards lower photon energy compared to FSP CuO, implying a decrease in oxidation state of Cu within the catalyst. This finding is further supported by a higher intensity of untreated CuO in the white line intensity. Moreover, pCuO-5 displays a higher intensity in the pre-edge region, probably due to a higher distortion in its crystal structure (inset in FIG. 3h). Hence, the forbidden transitions of 1 s to 3d are then partially allowed and can be more clearly observed. To provide an even more precise image of the coordination environment of our as-prepared catalysts, extended X-ray absorption fine structure (EXAFS) was carried out to reveal the local structure of Cu (FIG. 3i). The EXAFS fitting results reveal that the oxidation state of the Cu is shifted from +2 to +1.5 arising from oxygen vacancy defect generation.

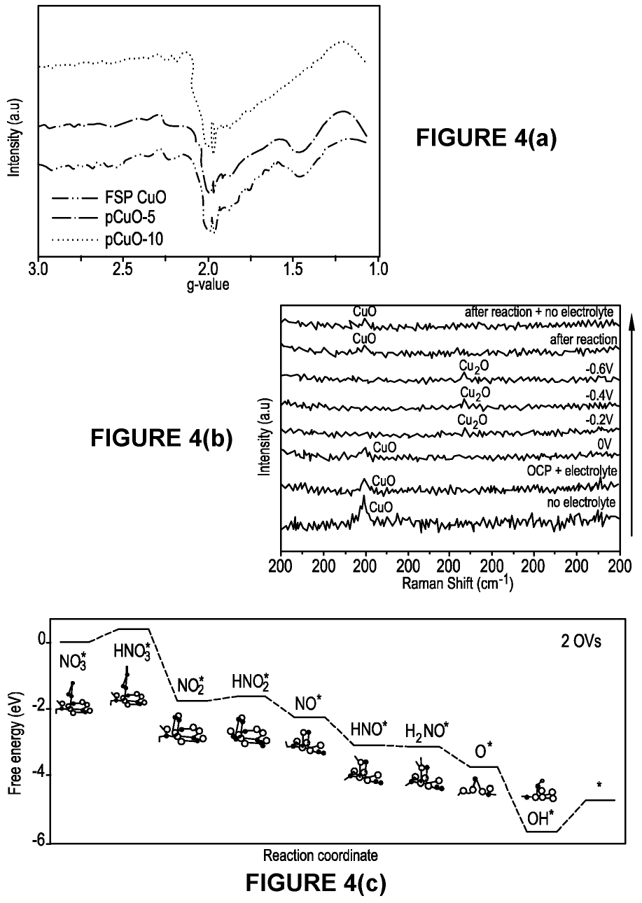

Electron paramagnetic resonance (EPR) measurements were carried out to further verify the formation and nature of defects that are generated on the CuO catalysts during the FSP process and subsequent plasma treatment. The EPR spectra (FIG. 4a) reveals a distinct and sharp peak at g value of 2.002 for all the catalysts, indicating the formation of ionically bonded superoxide species. These species can be formed by the interaction of 02 molecules and oxygen vacancies with one trapped electron, suggesting the presence of such defects within our catalysts. Using double integration of EPR peak intensity it was confirmed that there was an increase in vacancy with increasing plasma-treatment, in agreement with the above XPS and Raman results. Note that the minor intensity peaks at g value 2.045 and 2.3 is related to Cu²⁺, which is paramagnetic in nature.

In-situ optical emission spectroscopy (OES) measurements were also carried out during plasma-treatment to better understand the inducement of defects from the ionized species generated from He plasma.

Operando Raman spectroscopy was also used to investigate any change in the surface chemistry of CuO nanomaterials as a result of applied negative bias during NOₓRR. This is of importance, to understand and confirm if the active sites proposed theoretically and validated experimentally remain stable during reaction. The Raman spectra for pCuO-5 at different applied potential including open-circuit potential (OCP) with and without electrolyte and after applying potential is presented in FIG. 4b. Generally, a slight red-shift with all Raman spectra was observed in the operando measurements which arises from surface strain caused by re-orientation of atoms on surface of catalyst when exposed to aqueous electrolyte.⁴⁹ The Raman spectra for pCuO-5 at (i) OCP (carried out without electrolyte to establish background) and (ii) upon addition of electrolyte (OCP+electrolyte) revealed signal at ˜300 cm⁻¹ that correspond to A_{g} vibration modes for CuO. Applying various cathodic potential from 0 V to −0.6 V vs RHE and led to the observation that the intensity of Raman signal at wavenumber 300 cm⁻¹ decreases and eventually disappears with negative potential while distinct peaks at 420 cm⁻¹ and 460 cm⁻¹ corresponding to formation of Cu₂O are being formed. Notably, this transformation of catalyst surface is shown to be reversible as when negative bias is no longer applied, the Raman spectra matches the pre-reaction spectra (OCP and OCP+electrolyte). Using post-reaction XPS measurement, some partial reduction of CuO to Cu₂O was observed. Overall, the inventors results corroborate that CuOₓ active sites (i.e. a combination of CuO and Cu₂O) are present during NOₓRR catalysis.

Through correlation of the structure activity relationship, it has been possible to experimentally validate the beneficial role of oxygen vacancy defects within CuOₓ for nitrate reduction to ammonia as proposed by our initial theoretical studies (FIG. 1e-f). A short plasma-treatment (5 minutes) leads to an increase in defect density, as evidenced by a suite of characterization results (HAADF, XPS, XAS and EPR), leading to formation of active CuOₓ species (that are confirmed present during NOₓRR catalysis). This combination of beneficial defects while maintaining morphology, crystallinity and CuOₓ active sites allows the pCuO-5 to exhibit high selectivity and yield towards NH₄_{⁺} generation from NO⁻, when compared to background FSP CuO (FIG. 2). While longer plasma-treatment (10 minutes) leads to greater formation of oxygen vacancy benefitting NOₓRR (and causing improved NH₄_{⁺} yield), this is accompanied by a decline in surface crystallinity and lower electron density. Hence, these factors and the faster reaction kinetics of HER contribute to lower NH₄₊ selectivity on this electrode despite consisting of improved NOₓRR active sites.

Further DFT calculations were carried out to understand the reaction mechanism of NOₓRR on the defective CuO (111) surface. The surface model with 2 OVs is chosen as a model to detail the mechanism (FIG. 4c) on pCuO-5. As shown in FIG. 1e, the first step in NOₓRR is the adsorption of the NO₋₃ ion (facilitated by greater formation of oxygen vacancy defects), which occurs via the bonding of two O atoms of the ion with the surface Cu atoms with an adsorption energy of −1.87 eV. Following this, NO⁺ is reduced by H⁺ and e⁻ to NO₂OH⁺ or HNO⁺ (FIG. 4c), in which the H favorably bonds with the free O atom far from the surface. This is followed by another reduction reaction by H⁺ and e⁻ leading to the elimination of a single water molecule and leaving behind NO⁺ on the surface. In agreement with literature, the next proton-electron pair favorably attacks the N atom of NO⁺, thus forming HNO₊₂ which is then further reduced by proton-electron pairs to form NO⁺, HNO⁺ and H₂NO⁺. Subsequently, another proton-electron pair will reduce H₂NO⁺ to form O⁺ and release a molecule of NH₃. The cycle is then closed by the formation of OH⁺ and subsequent regeneration of the surface (⁺) by the release of another H₂O molecule.

Thus, the present invention has established that the oxygen vacancy defects within CuO nanomaterials lower the free energy change for electrochemical nitrate reduction to ammonia. This was validated experimentally by carrying out plasma treatment with FSP prepared defective CuO nanomaterials to manipulate the amount of oxygen vacancies with one trapped electron within CuO. A direct dependence was observed of this defect density with NH₄_{⁺} yield during NOₓRR. The optimized plasma-treated CuO is capable of generating NH₄_{⁺} with an unprecedented yield of 520 μmolcm⁻²h⁻¹ with good stability at 2.2 V.

Preliminary experiments have been conducted with SnO₂, CeO₂, and Bi₂O₃ as the starting metal oxide which have been treated with plasma to engineer an oxygen vacancy at the surface of the metal oxide. These metal oxides with oxygen vacancy gave positive results in the conversion of NOₓ to NH₄_{⁺} and/or NH₃. The SnO₂ is capable of converting NOₓ to NH₄_{⁺} in alkaline environment with a yield>20 nmols⁻¹ cm⁻². This illustrated the general applicability of the catalysts and methods of the present invention.

### EXPERIMENTAL

### Materials

All chemical reagents and solvents utilized in this work were used as received and without any further purification. Deionized water (resistivity 18.2 MΩ cm⁻¹) was used in all experiments.

### Catalyst Synthesis

CuO nanoparticles were prepared with a flame spray pyrolysis (FSP) system. A copper precursor solution comprised of copper 2-ethylhexanoate (Sigma-Aldrich, 92.5-100%) in xylenes (Sigma-Aldrich, reagent grade) was prepared in a manner that the Cu concentration in solution was 0.5 M. This precursor solution was fed to the FSP system with a flow rate of 5 mL min⁻¹ using a syringe pump and was atomized using an oxygen flow of 5 mL min⁻¹ (Coregas, 99.9%). The flame was ignited and maintained with a supporting flame mixture which consisted of 3.2 L min⁻¹ oxygen and 1.5 L min−1 methane (Coregas, >99.95%). The flame was directed with the aid of a 5 L min⁻¹ flow of oxygen and a vacuum pump toward a glass fiber filter, where the CuO nanomaterials were deposited and collected. To prepare pCuO-5 and pCuO-10, the CuO nanomaterials prepared using FSP was plasma-treated in the presence of He gas for a duration of 5 and 10 minutes, respectively.

### Electrochemical Experiments

All electrochemical measurements were carried out using a CHI 760E (CH Instrument, Texas) electrochemical workstation. To prepare CuO working electrodes, 5 mg of the CuO catalysts were dispersed in 0.5 mL deionized water and ethanol solution (1:1, v/v), followed by the addition of 25 μL of Nafion solution (Sigma-Aldrich), and sonicated to form inks, which were then drop-casted on carbon fiber paper to attain a catalyst loading of 0.5 mg cm⁻². The working electrodes were then placed with a saturated calomel reference electrode in the cathodic compartment of a customized H-cell that is separated from the anode compartment which contains a Pt wire as counter electrode using a commercial Nafion membrane. All potentials measured in this study were converted to the reversible hydrogen electrode (RHE) reference for the purpose of comparison, using the following equation: E_{RHE} (V)=E_{SCE} (V)+0.245+0.059×pH. For testing in flow electrolyzer, a MEA was prepared by sandwiching 4 cm² pCuO-5 electrode prepared by spraying the catalyst ink on carbon fiber paper and commercial Ru/TiO₂ electrode between a commercial Nafion membrane. The MEA was then placed within a custom-designed electrolyzer where 1 M KOH was circulated through both cathode and anode at a flowrate of 10 mL/min. Note all j reported herein is normalized to the geometric surface area without any iR compensation. EIS was measured under −0.4 V vs RHE in 0.5 M Na₂SO₄ with the frequency from 100 kHz to 0.1 Hz. Different scan rates were used in the cyclic voltammetry measurement at the potential window of 0.6 to 0.8 vs RHE to obtain the electrochemical capacitance current for the evaluation of the relative electrochemically active surface area (ECSA).

### Product Analysis

Post-reaction, 0.5 mL of catholyte was collected for analysis using indophenol-blue test to determine NH₃ concentration. The catholyte was pipetted into a 1.5 mL sample tube followed by the addition of (i) 0.4 mL of 1 M sodium hydroxide solution (Sigma Aldrich, 99.99%) that consists of 5 wt. % salicylic acid (Sigma Aldrich, 99.99%), 5 wt. % sodium citrate (Sigma Aldrich, 99.99%), (ii) 0.1 mL of 0.05M sodium hypochlorite solution (Sigma Aldrich, 99.99%)) and (iii) 30 μL of 1 wt. % sodium nitroferricyanide solution ((Sigma Aldrich, 99.99%), sonicated thoroughly and incubated in the dark at room temperature for a duration of two hours. Dilution of the electrolyte was required as ammonia concentration was high. Afterwards, a Shimadzu UV-3600 UV-vis-NIR spectrophotometer was employed to quantify the amount of ammonia being produced from the electrocatalysis process. The absorbance readings between 550 to 850 nm wavelengths were measured. By using the peak absorbance reading, the performances of all catalysts in generating ammonia were assessed in terms of Faradaic efficiency, and ammonia yield.

### Physical Characterization

The morphology of CuO were investigated using a high-resolution transmission electron microscope (HR-TEM) JEOL 2100F operating at 200 kV. XRD was carried out using PANalytical X'Pert instrument using Cu K∝ radiation (λ=1.54 Δ) with a scan range from 10° to 90°. Surface chemical composition was evaluated using XPS with a Thermo ESCALAB250i X-ray photoelectron spectrometer. The presence of oxygen vacancies and defects formation were evaluated using electron paramagnetic resonance (EPR) spectroscopy on a Bruker EMX-plus X-Band EPR spectrometer at 9.41 GHz (X-band) at room temperature where the microwave power was set at 2 mW and the modulation amplitude at 5 G. Raman spectrum was observed using an inVia 2 Raman Microscope with 532 nm (green) diode laser with 1800 l/mm grating, the laser power at the sample position was typically 350 μW with an average spot size of 1 μm in diameter. For carrying out operando Raman measurements, a screen-printed microelectrode (SPE, Metrohm) was used as substrate where the counter and reference electrodes are Au and Ag wire, respectively. To prepare the working electrode, a catalyst ink was prepared by dissolving 1.25 mg of pCuO-5 in 0.5 mL of deionized water, 0.5 mL of ethanol and 50 μl Nafion® 117 solution (˜5% Nafion) by sonication. 2 μl of the catalyst ink was drop-casted on the working area on the SPE (diameter of 4 mm) and dried overnight (catalyst loading: ˜0.019 mg cm⁻²). When running experiments, SPE and CHI 660E potentiostat (CHI Instrument, Texas) was connected and placed under a confocal HORIBA LabRAM Raman microscope and a 532 nm continuous-wave diode-pumped solid-state (CPSS) diode laser was used as excitation source. The laser was focused on the catalyst surface using a 50× objective lens with a numerical aperture of 0.55. The on-sample illumination spot size was ≈5 microns in diameter, and the on-sample power was kept constant at ˜5.5 mW. The Raman spectra were captured using a silicon charge-couple-device (CCD) detector in the wavenumber ranging from 150 to 1000 cm⁻¹.

1. A metal oxide catalyst comprising a metal oxide having engineered surface defects in the form of oxygen vacancy defects.

2. The metal oxide catalyst according to claim 1 wherein the metal oxide is in high surface area form.

3. The metal oxide catalyst according to claim 1 or 2 in the form of nanoparticles.

4. The metal oxide catalyst according to any one of the preceding claims wherein the metal is a transition metal, a lanthanide metal, or a post transition metal.

5. The metal oxide catalyst according to any one of the preceding claims wherein the metal is copper, cerium, tin or bismuth.

6. The metal oxide catalyst according to any one of the preceding claims wherein the metal is copper.

7. The metal oxide catalyst according to any one of the preceding claims further supported on a substrate.

8. The metal oxide catalyst according to claim 5 when the substrate is a carbon substrate.

9. The metal oxide catalyst according to claim 8 when the carbon substrate is a carbon fibre substrate.

10. The metal oxide catalyst according to any one of the preceding claims wherein the engineered surface defects are created by plasma treatment of the metal oxide.

11. The metal oxide catalyst according to claim 10 wherein the plasma treatment is treatment with a plasma selected from a helium plasma, an argon plasma, a hydrogen plasma, a nitrogen plasma, an air plasma or mixtures thereof.

12. The metal oxide catalyst according to claim 11 wherein the plasma treatment is treatment with a plasma selected from a helium plasma or, an argon plasma.

13. A metal oxide catalyst according to any one of claims 10 to 12 wherein the plasma treatment is applied for a time sufficient to create oxygen vacancy defects while maintaining morphology and crystallinity of the metal oxide surface without inducing surface amorphization.

14. A metal oxide catalyst according to claim 13 wherein the plasma treatment is applied for 3-7 minutes.

15. A metal oxide catalyst according to claim 13 wherein the plasma treatment is applied for 5 minutes.

16. A method of producing a metal oxide catalyst for NOₓ reduction, the method comprising:
preparing a high surface metal oxide catalyst; and
plasma treating the metal oxide particle to induce a controlled level of defects.

17. The method of claim 16 wherein the step of preparing a high surface metal oxide catalyst is by a process selected from flame spray pyrolysis, electrodeposition, hydrothermal synthesis or precipitation.

18. The method of claim 17 wherein the plasma surface modification is conducted by one or more of a helium plasma, an argon plasma, a hydrogen plasma, a nitrogen plasma, an air plasma or mixtures thereof applied for a time sufficient to create oxygen vacancy defects while maintaining morphology and crystallinity of the metal oxide surface without inducing surface amorphization.

19. The method according to claim 18 wherein the plasma treatment is applied for 3-7 minutes.

20. The method according to claim 18 wherein the plasma treatment is applied for 5 minutes.

21. A metal oxide catalyst prepared by the method of any one of claims 16 to 20.

22. A method of producing NH₄_{⁺} from NOₓ comprising depositing a metal oxide catalyst of any one of the claims 1-15, or a metal oxide catalyst prepared according to any one of claims 16 to 21, onto a substrate to provide an electrode, or a metal coordinated with nitrogen doped carbon, contacting the electrode with an aqueous solution containing NOx species and applying a current to the electrode to reduce NOx species to NH₄_{⁺}/NH₃.

23. A method according to claim 22 further comprising the step of monitoring NOx reduction by analysis of NH₄_{⁺} production in the aqueous solution.

24. A method of producing NH₃ from NOx comprising depositing a metal oxide catalyst of any one of claims 1-15, or a metal oxide catalyst prepared according to any one of claims 16 to 21 onto a substrate to provide an electrode, contacting the electrode with an aqueous basic solution containing NOx species and applying a current to the electrode to reduce NOx species to NH₃.

25. The method of claim 24 further comprising the step of monitoring NOx reduction by analysis of NH₃ production in the aqueous basic solution.

26. The method of claim 24 carried out in the gas phase, where NOx species and a hydrogen donor in gas form are passed over the catalyst of the present invention.

27. The method of any one of claims 22-26 wherein the NOx is part of a waste stream.
